(19) United States
(12) Patent Application Publication
(10) Pub. No.: US 2011/0164407 A1
(43) Pub. Date: Jul. 7, 2011

(54) LINEAR CONFIGURATION LIGHTING MODULE AND APPLICATION THEREOF

(75) Inventors: Thomas E. Stack, Oxford, MI (US); David E. Douglas, Oak Park, MI (US)

(73) Assignee: Q TECHNOLOGY, INC., Livermore, CA (US)

(21) Appl. No.: 13/051,598

(22) Filed: Mar. 18, 2011

Related U.S. Application Data
(63) Continuation-in-part of application No. 12/976,922, filed on Dec. 22, 2010.
Application No. 12/976,922 is a continuation of application No. 11/973,430, filed on Oct. 9, 2007, now Pat. No. 7,862,195.
(60) Provisional application No. 61/315,946, filed on Mar. 20, 2010.
(60) Provisional application No. 60/850,030, filed on Oct. 6, 2006.

(51) Int. Cl. A47F 11/10; F21V 7/00

(52) U.S. Cl. 362/125; 362/217.05

(57) ABSTRACT

A display case having end jamb lighting module and a center mullion lighting module is disclosed. The lighting modules include a shell and at least one substrate whereon lighting elements are mounted. The shell defines engagement slots used to affix the substrate to the shell. The shell defines an aperture allowing light from the lighting elements to be projected out. The lighting module may include a second substrate upon which electrical components are mounted, the electrical components for conditioning input power for the lighting elements. A reflective portion of the shell or a separate reflector mounted on the shell operates on the light to form a desired spatial distribution of light. An optical cover covers the aperture. The center mullion lighting module can include a third substrate for mounting of lighting elements. Alternatively, the center mullion lighting module can be formed by combining two end jamb lighting modules.

### REFERENCE TO RELATED APPLICATIONS

This application claims the benefit of the filing date of U.S. Provisional Patent Application No. 61/315,946 filed Mar. 20, 2010 entitled “Linear Configuration Lighting Module” under 35 USC sections 119 and 120; the entirety of the Provisional Application 61/315,946 is incorporated by reference herein, and the priority is claimed herein.

Additionally, this application is a Continuation-In-Part application of a current pending U.S. application Ser. No. 12/976,922, filed on Dec. 22, 2010, entitled, “Multiple Positioned Light Source to Achieve Uniform or Graded Illumination,” the entirety of which is incorporated by reference herein and priority of which is claimed herein.

The Ser. No. 12/976,922 application, in turn, claims benefit of U.S. application Ser. No. 11/973,430, filed on Oct. 9, 2007, entitled “Multiple Positioned Light Source to Achieve Uniform or Graded Illumination,” the entirety of which is incorporated by reference herein and priority of which is claimed herein.

The Ser. No. 11/973,430 application, in turn, claims the benefit of the filing date of U.S. Provisional Patent Application No. 60/850,030 filed Oct. 6, 2006 entitled “Multiple Positioned Point Sources to Achieve Uniform or Graded Illumination” under 35 USC sections 119 and 120, and said Provisional Patent Application also being incorporated herein by reference and priority of which is claimed herein.

### BACKGROUND

The present invention relates to various aspects of the lighting systems. In particular, the present invention relates lighting systems and illumination of partially or fully or enclosed spaces such as product display cases, grocery canopy, and under-shelf lighting in various display appliances.

The use of fluorescent lamps and lighting technology is well known in the lighting art. However, disadvantages of a fluorescent lamp and its ballast include the emission of heat as a side effect, which is counterproductive for use with a cooling apparatus. Further, unsafe conditions may occur in a fluorescent lighting system, including the possibility of high voltage arcing, which could either directly harm the installer, customers, or bystanders, or indirectly by starting a fire. The use of mercury in a fluorescent lamp poses a health hazard to store employees, customers or final consumers due to accidental breakage of a lamp allowing the mercury to contaminate the cabinet interior or product surfaces. Finally, fluorescent bulbs have a limited lifetime, requiring inconvenient replacement.

Attempts have been made in the art toward energy efficient solid state lighting such as light emitting devices (LED's). However, the existing lighting systems are wanting in a number of aspects including, for example, structural shortcoming, lack of modularity, difficulty in manufacture, high costs of manufacture, lack of uniformity in illumination, or a combination of any of these and other deficiencies.

Accordingly, there remains a need for an improved illumination system and technology for more uniform or controlled gradient illumination of substantially enclosed spaces.

### SUMMARY

The need is met by the present invention. In a first embodiment of the present invention, a display case includes panels that define at least partially enclosed space. The display case has a first end jamb and a first end jamb lighting module running along the first end jamb. The first end jamb lighting module includes a lighting module shell, a first substrate affixed to the shell, and lighting elements mounted on the first substrate. The lighting elements can be, for example, light emitting diodes.

In the display case, the panels define a second end jamb and a center mullion. A second end jamb lighting module runs along the second end jamb. A center mullion lighting module runs along the center mullion. The second end jamb lighting module includes a shell, a first substrate affixed to the shell, and lighting elements mounted on said first substrate.

In some embodiments, the center mullion lighting module includes a third end jamb lighting module oriented in a first direction, and a fourth end jamb lighting module mounted proximal to said third end jamb lighting module. The fourth end jamb module is oriented in a second direction.

In other embodiments, the center mullion lighting module includes a shell, a first substrate, a second substrate, and a third substrate, all substrates affixed to the shell. Lighting elements are mounted on the first substrate. Electrical components are mounted on the second substrate, the electrical components connected to the lighting elements of the first substrate. Lighting elements are mounted on the third substrate.

In the display case, the shell defines a plurality of engagement slots such that the first substrate is affixed to the shell by placing portions of the first substrate within the engagement slots. In the display case, the first end jamb lighting module includes a second substrate affixed to the shell and electrical components mounted on the second substrate, the electrical components connected to the lighting elements of the first substrate. The substrates can be affixed to the shell using other methods such as, for example, screws, adhesive, or clips.

In the display case, the shell defines an aperture through which light from the lighting elements is projected, and a reflective surface is located proximal to the aperture.

Alternatively to the reflective surface, or in combination with it, the shell defines an aperture through which light from the lighting elements is projected, and the first end jamb lighting module includes a reflector positioned proximal to the aperture. The reflector is adapted to reflect light from the lighting elements in a desired direction or in a desired spatial distribution.

In the display case, the shell defines an aperture through which light from the lighting elements is projected and the first end jamb lighting module includes an optical cover covering at least a portion of the aperture. The shell may also define a cover tuck insert to which a portion of the cover engages.

In the display case, the first lighting module includes a quick-disconnect connector adapted to engage with a mated connector through which external electrical power is supplied to the first lighting module.

In a second embodiment of the present invention, a display case includes panels defining at least partially enclosed space, the panels also defining a first end jamb, a second end jamb, and a center mullion. A first end jamb lighting module runs along the first end jamb. A second end jamb lighting module runs along the second end jamb. A center mullion lighting module runs along center mullion. Each lighting module includes a lighting module shell; a first substrate affixed to the shell; and lighting elements mounted on the shell.

Each lighting module further includes a second substrate affixed to the shell and electrical components mounted on the second substrate, the electrical components connected to the lighting elements. Further, each shell defines at least one aperture, and each lighting module includes a reflective surface proximal to the aperture.

In a third embodiment of the present invention, a lighting module includes a lighting module shell, the shell defining at least one engagement slot; a first a substrate affixed to the shell at the engagement slot; and lighting elements mounted on the substrate. In the lighting module, the shell includes a reflector flange portion for supporting a reflector adapted to reflect light from the lighting elements toward a desired direction. Alternatively, the reflector flange portion can be adapted to reconfigure the spatial distribution of light from the lighting elements.

In the lighting module, the shell defines a cover flange; the shell defines a tuck insert; and an optical cover partially wraps around the cover flange and edge of the optical cover is inserted into the tuck insert. The lighting module further includes a first end plate fastened to a first end of the shell, and a second end plate fastened to a second end of the shell.

### BRIEF DESCRIPTION OF THE DRAWINGS

FIG. 1 is a front perspective view of a display case according to one embodiment of the present invention;

FIG. 2 is a rear perspective view of the display case of FIG. 1;

FIG. 3 illustrates a cut-away top view of the display case of FIGS. 1 and 2 cut along plane A-A;

FIG. 4 is a perspective view of a lighting module according to another embodiment of the present invention;

FIG. 5 is a top view of the lighting module of FIG. 4;

FIGS. 6 and 7 are end views of the lighting module of FIG. 4;

FIG. 8 is a perspective exploded view of portion B of the lighting module of FIG. 4;

FIG. 9 is a cut away cross sectional view of the lighting module of FIG. 4 cut along line C-C illustrated in FIG. 5;

FIG. 10 is a portion of the away cross sectional view of the lighting module of FIG. 4 cut along line C-C illustrated in FIG. 5;

FIG. 11 illustrates an alternative embodiment of a portion of the lighting module of FIG. 4;

FIG. 12 is a cut away cross sectional view of the portion illustrated in FIG. 11 with additional elements;

FIG. 13 is a perspective view of a lighting module according to yet another embodiment of the present invention;

FIG. 14 is a top view of the lighting module of FIG. 13;

FIG. 15 is a perspective exploded view of portion D of the lighting module of FIG. 13;

FIG. 16 is a cut away cross sectional view of the lighting module of FIG. 13 cut along line E-E illustrated in FIG. 14;

FIG. 17 is a portion of the away cross sectional view of the lighting module of FIG. 13 cut along line E-E illustrated in FIG. 14;

FIG. 18 illustrates an alternative embodiment of a portion of the lighting module of FIG. 13; and

FIG. 19 illustrates an alternative embodiment a portion of the display case of FIGS. 1 and 2.

### DETAILED DESCRIPTION

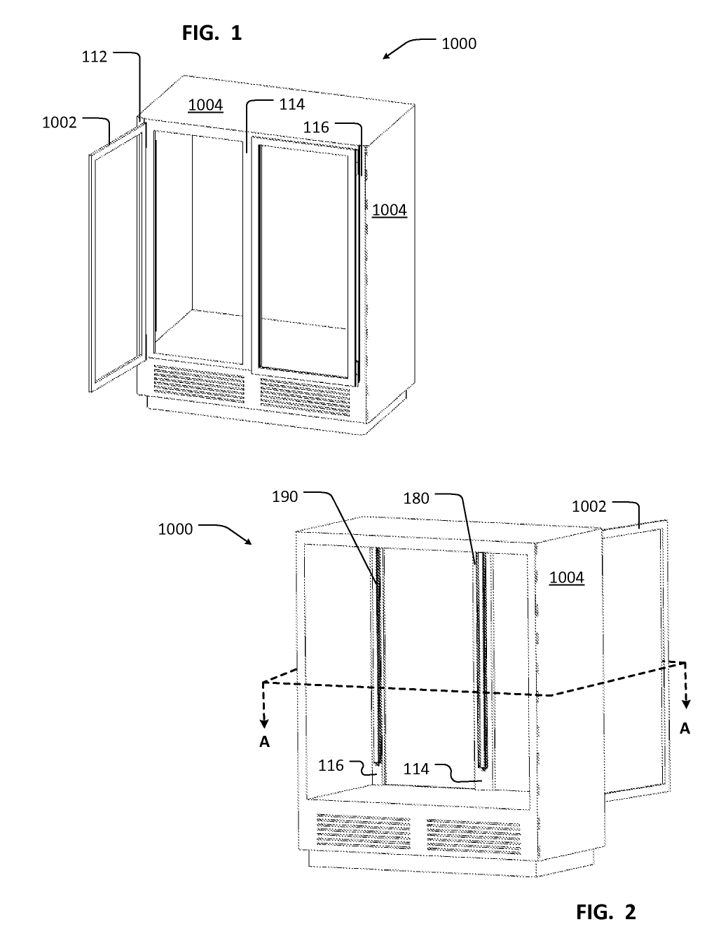

The present invention will now be described with reference to the FIGS. 1 through 19 which illustrate various aspects, embodiments, or implementations of the present invention. In the Figures, some sizes of structures, portions, or elements may be exaggerated relative to sizes of other structures, portions, or elements for illustrative purposes and, thus, are provided to aid in the illustration and the disclosure of the present invention.

FIG. 1 is a front perspective view of a display case 1000 according to one embodiment of the present invention. FIG. 2 is a rear perspective view of the display case of FIG. 1 but without a back panel such that the partial interior view is possible. Referring to FIGS. 1 and 2, according to the illustrated aspect of the present invention, the display case 1000 includes a number of panels such as top and side panels 1004, and doors or windows 1002 either of which may be openable. The display case 1000 is illustrated defining a substantially enclosed space. The present invention is applicable to many contexts and appliances such as, for example, grocery display fixtures in supermarkets; salad display stations at restaurants.

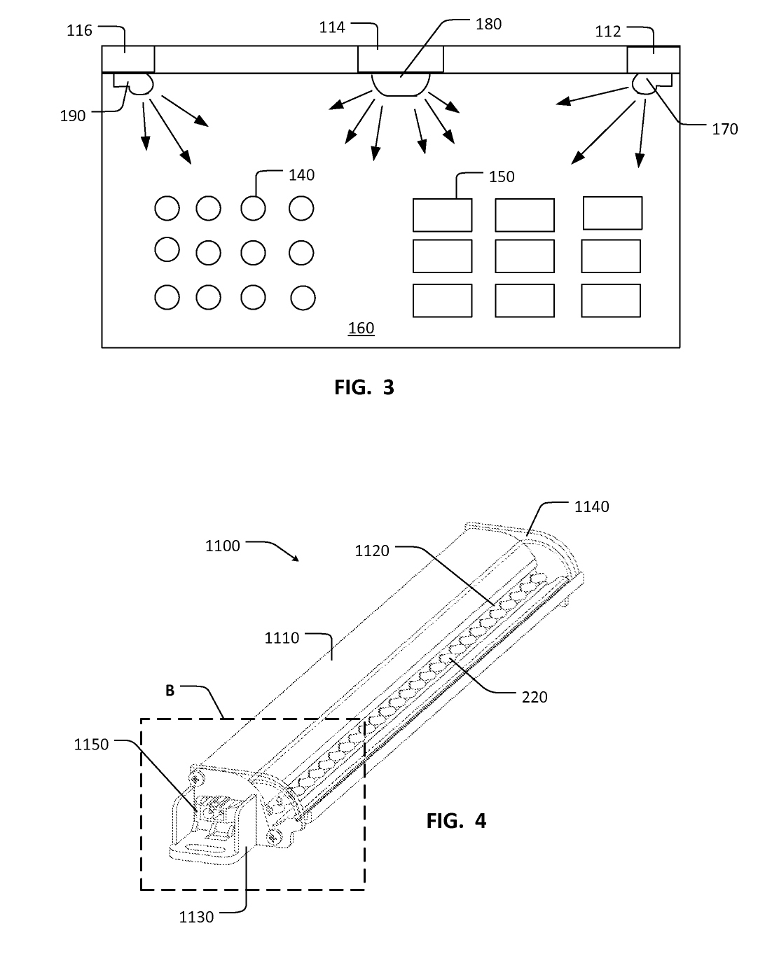

FIG. 3 illustrates a cut-away top view of the display case 1000 cut along plane A-A of FIG. 2 looking downward including a shelf 160. Referring now to FIGS. 1 through 3, the shelf 160 is not illustrated in FIGS. 1 and 2 to avoid clutter in these Figures; however, it is expected that the display case 1000 enclosed a plurality of shelves on which a number of products 140 and 150 are placed and displayed. The products 140 and 150 are shown for illustrative purposes only and illumination for other product selection and layout is within the scope of this development.

Referring to FIGS. 1 through 3, the panels 1004 and doors or windows 1002 meet to define mullions, end jambs, or corners. The outermost vertical members 112 and 116, providing support at the panels 1004 of the display case 1000 are referred to as end jambs. Inner vertical member 114 dividing between window or door partitions is referred to as center mullion 114. The display case 1000 has a first end jamb 112 and a second end jamb 116.

At each of the end jambs 112 and 116, an end jamb lighting module runs along the end jamb. As illustrated, a first end jamb lighting module 170 runs along the first end jamb 112, and a second end jamb lighting module 190 runs along the second end jamb 116. A center lighting module 180 runs along the center mullion 114.

### End Jamb Lighting Module

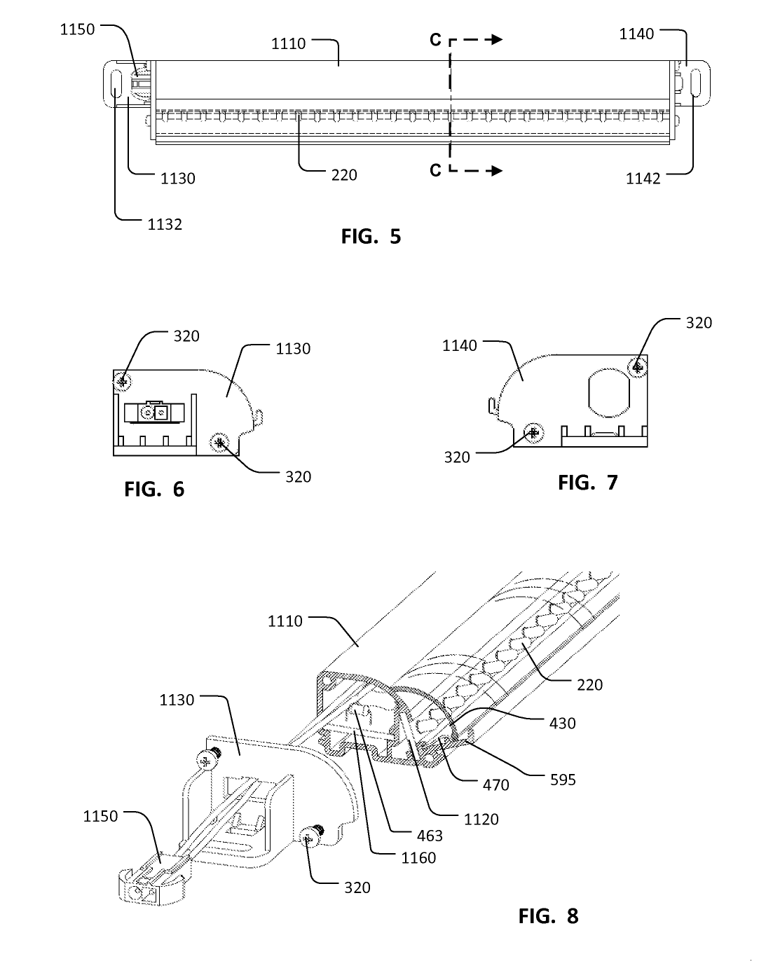

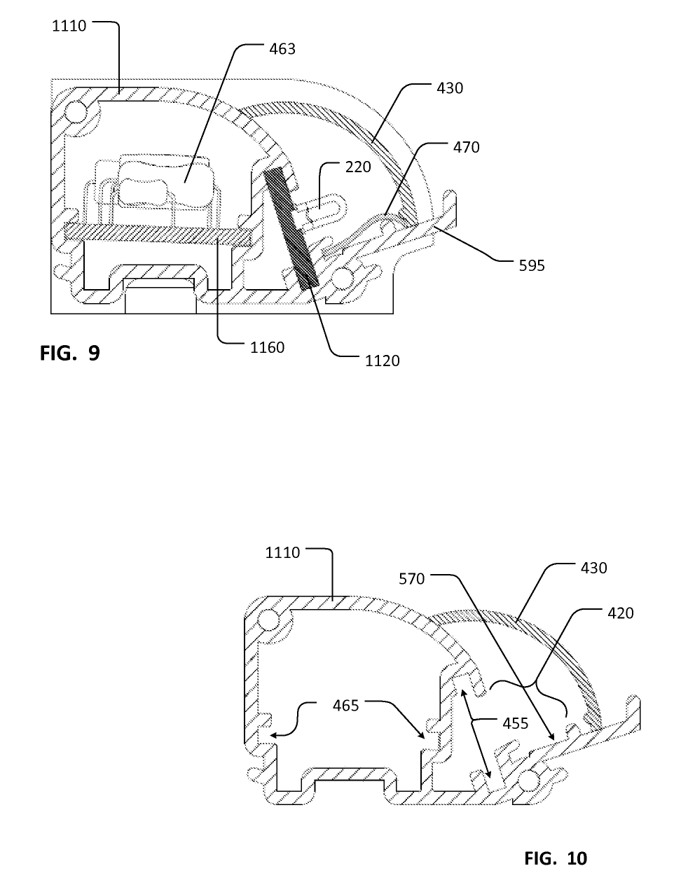

FIG. 4 is a perspective view of an end jamb lighting module in accordance with another embodiment of the present invention. FIG. 5 is a top view of the lighting module of FIG. 4. FIGS. 6 and 7 are views of end portions of the lighting module of FIG. 4. FIG. 8 is an exploded illustration of portion B of the lighting module of FIG. 4. FIG. 9 is a cut-away cross sectional view of the lighting module of FIG. 4 cut at line C-C. FIG. 10 is a cut-away cross sectional view of the lighting module of FIG. 4 cut at line C-C but showing only selected portions of the lighting module.

Referring to FIGS. 4 through 10, an end jamb lighting module 1100 in accordance with another embodiment of the present invention is shown. The end jamb lighting module 1100 corresponds to the lighting modules 170 and 190 in FIGS. 1 through 3. The lighting modules 170 and 190 of FIGS. 1 through 3 have similar construction. The end jamb lighting module includes a lighting module shell 1110, a first substrate 1120, and lighting elements 220. End cap plates 1130 and 1140 cap the ends of the lighting module 1100. The first end cap plate 1130 is fastened to the first end of the shell 1110. The second end cap plate 1140 is fastened to the second end of the shell 1110. The end caps 1130 and 1140 may be made of polyvinyl chloride (PVC), metal or other suitable material. An extrusion process may produce the shell 1110.

The first substrate 1120 can be a printed circuit board (PCB). The lighting elements 220 are, for example, LED's 220, and are mounted on the first substrate 1120. The first substrate 1120 is affixed to the shell 1110. Devices and means for affixing the first substrate 1120 to the shell 1110 can vary. For example only, the first substrate 1120 can be screwed to the shell 1110, attached using adhesives to the shell 1110, or clipped to the shell 1110.

In the illustrated embodiment, the shell 1110 defines a plurality of engagement slots 455 and 465 such that the first substrate is 1120 affixed to the shell 1110 by placing portions of the first substrate 1120 within the engagement slots. Here, two sets of engagement slots 455 and 465 are illustrated. Again, in the illustrated embodiment, the first substrate is 1120 affixed to the shell 1110 by placing portions of the first substrate 1120 within the first set of engagement slots 455.

A second set of engagement slots 465 is used to affix a second substrate 1160 to the shell 1110. Electrical components 463 are mounted on the second substrate 1160. The electrical components 463 are connected to the lighting elements 220 of the first substrate 1120. The electrical components 463 can include power conditioning circuitry such as diodes, resistors, and capacitors.

The shell 1110 defines an aperture 420 through which light from the lighting elements 220 is projected. The end jamb lighting module 1100 includes a reflector 470 positioned proximal to the aperture 420. The reflector 470 is adapted to reflect light from the lighting elements 220 to reconfigure spatial distribution of the light so as to more uniformly illuminate the product on display or to emphasize selected features (for example, a product label or price tag). The reflector 470 may be constructed of shiny tape, metalized glass or plastic or the like, a metallic strip, or be applied by vapor deposition. Otherwise, a white or metallic finish casing of the shell 1110 may reflect enough light so as to not need an additionally mounted reflector.

The end jamb lighting module 1100 includes an optical cover 430 covering at least a portion of the aperture 470. In the illustrated embodiment, the optical cover 430, combined with the end caps 1130 and 1140, completely encloses the aperture 420. Each of the end caps 1130 and 1140 define a mounting hole 1132 and 1142 allowing the end jamb lighting module 1100 to be mounted to the display case 1000 using mounting devices such as, for example only, screws. The cover 430 may be glass, transparent plastic, or other optical clear or semi-clear material. If desired, the optical cover 430 may be configured to modify the light path and act as a lens, though it may also be advantageous in some applications to minimize and make uniform the optical cover thickness to reduce distortion and absorption.

The shell 1110 also includes a reflector flange portion 595 for supporting the reflector 470 adapted to reflect light from the lighting elements toward a desired direction. The flange 595 may also be used to block some of the side light that could be visible to the customer from outside the case. Alternatively, the shell may include a reflective surface 570 portion proximal to the aperture 420. In such case, the reflector 470 may not be needed.

The end jamb lighting module 1100 includes a quick-disconnect connector 1150 adapted to engage with a mated connector through which external electrical power is supplied to the first lighting module.

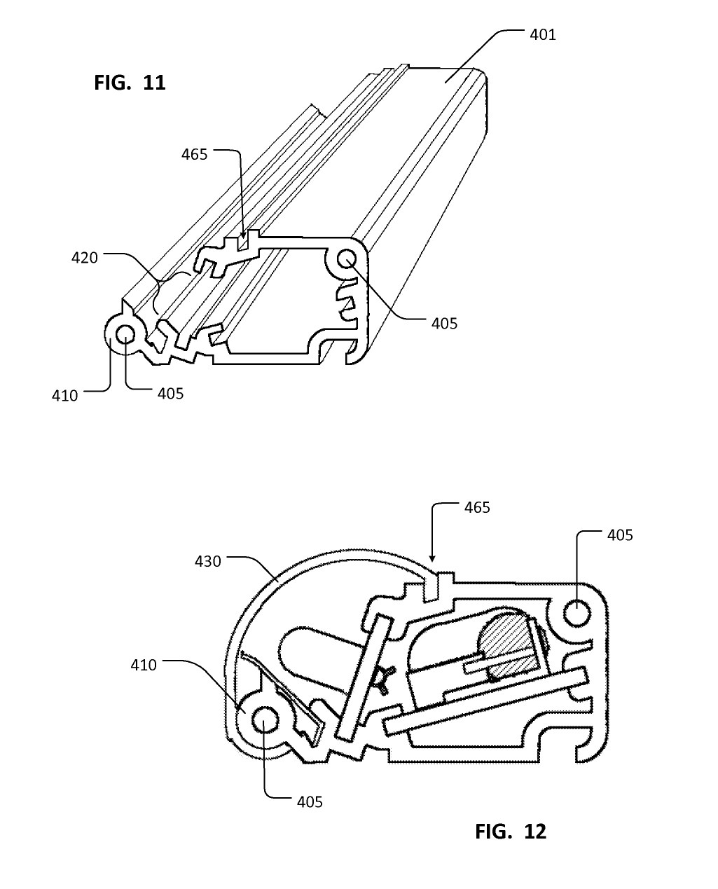

FIG. 11 illustrates an alternative embodiment 401 of the end jamb module shell 1110 for the end jamb lighting module 1100 of FIGS. 4 through 10. FIG. 12 is a cut-away cross sectional view of the shell 1110 of FIG. 11 but with additional elements. Most of the portions and the components of the lighting module of including shell 401 are similar to corresponding portions and corresponding components of the lighting module 1100 of FIGS. 4 through 10. However, the shell 401 of FIGS. 11 and 12 includes some new features. For one, the shell 401 defines a cover tuck insert slot 465 proximal to the aperture 420. The edge of an optical cover 430 may be inserted to the tuck insert 465 for secure attachment. The opposing edge of the optical cover 430 can be secured by wrapping it, at least partially, around a cover flange portion 410 of the shell. In the illustrated embodiment, the cove flange portion 410 also functions as an encircling material 410 for a hole that is a fastener receiver 405. That is, the cover flange 410 defines a hole 405 that receives mounting screws 320 (of FIGS. 6 through 8) of the end plates 1130 and 1140 thereby allowing attachment of the end plates 1130 and 1140 to the shell 401.

### Center Mullion Lighting Module

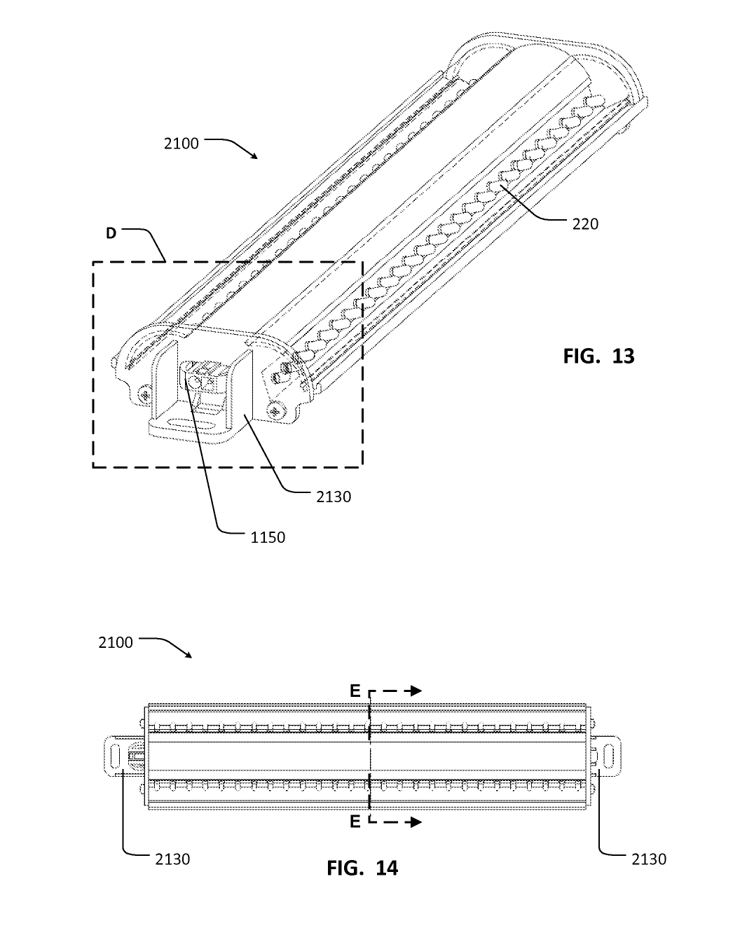

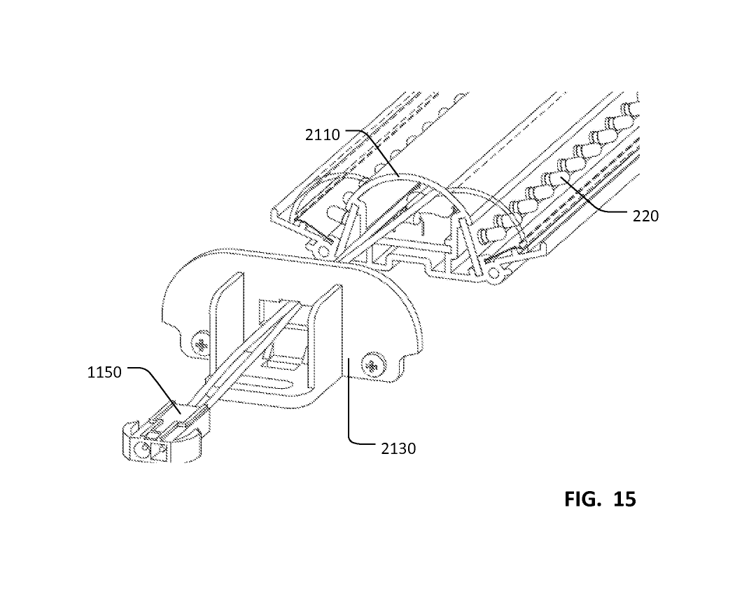

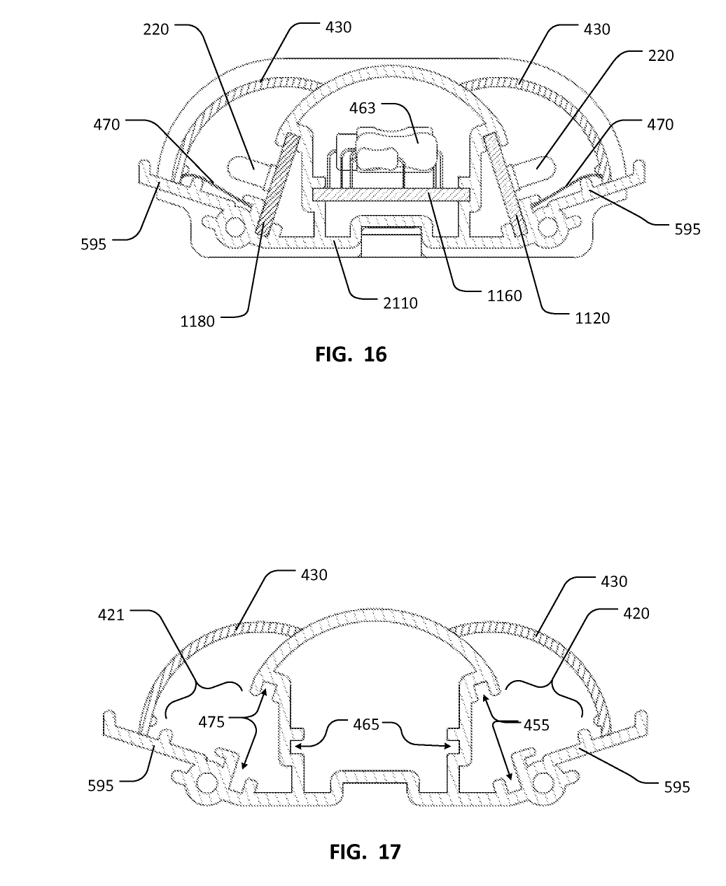

FIG. 13 is a perspective view of a center mullion lighting module 2100 in accordance with yet another embodiment of the present invention. FIG. 14 is a top view of the lighting module of FIG. 13. FIG. 15 is an exploded illustration of portion D of the lighting module of FIG. 13. FIG. 16 is a cut-away cross sectional view of the lighting module of FIG. 13 cut at line E-E. FIG. 17 is a cut-away cross sectional view of the lighting module of FIG. 13 cut at line E-E but showing only selected portions of the lighting module 2100.

The center mullion lighting module 2100 is a modified version of the end jamb lighting module 1100 of FIG. 4 through 10, modified to provide light in multiple directions. For this reason, portions of the center mullion lighting module 2100 are similar to corresponding portions of the end jamb lighting module 1100 of FIG. 4 through 10.

Referring to FIGS. 13 through 17, the lighting module 2100 includes the first substrate 1120 having lighting elements 220 mounted on it. The lighting module 2100 also includes the second substrate 1160 having electrical components 463 mounted on it. The electrical components 463 are connected to the lighting elements 220 of the first substrate 1120. The lighting module 2100 includes a third substrate 1180 that is configured similarly to the first substrate 1120. The third substrate 1180, a printed circuit board (PCB), also has lighting elements 220 mounted on it.

These substrates 1120, 1160, and 1180 are affixed to a central mullion lighting module shell 2110. The shell 2110, similar to the shell 1110 (of FIGS. 4 through 10) defines a plurality of engagement slots 455, 465, and 475 to which the substrates 1120, 1160, and 1180 are inserted. Again, similar to the lighting module 1100, the lighting module 2100 includes reflector flanges 595, reflectors 470, and optical covers 430. In this configuration, the central mullion lighting module 2100 provides light in at least two directions—the first direction by light provided through a first aperture 420, and the second direction by light provided through a second aperture 421.

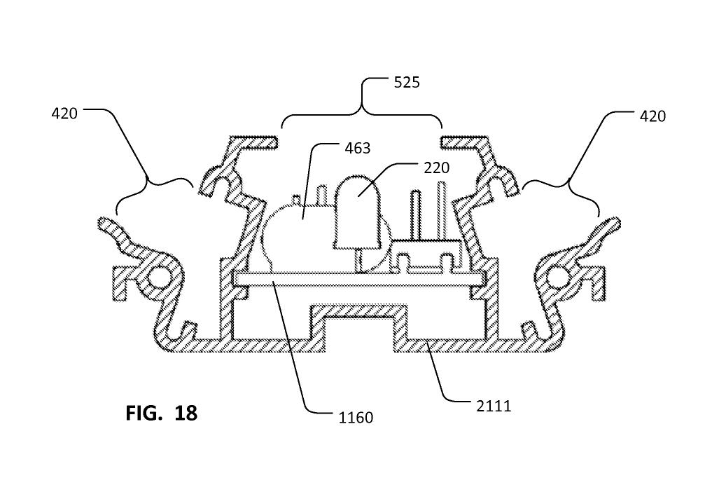

In an alternative embodiment of the central mullion lighting module shell 2110, the central mullion lighting module 2100 can be configured to provide light in three directions. FIG. 18 illustrates an alternate central mullion lighting module shell 2111 defining a third aperture 525. Furthermore, in this alternative embodiment, the second substrate 1160 is populated with light emitting elements 220 in addition to the electrical components 463.

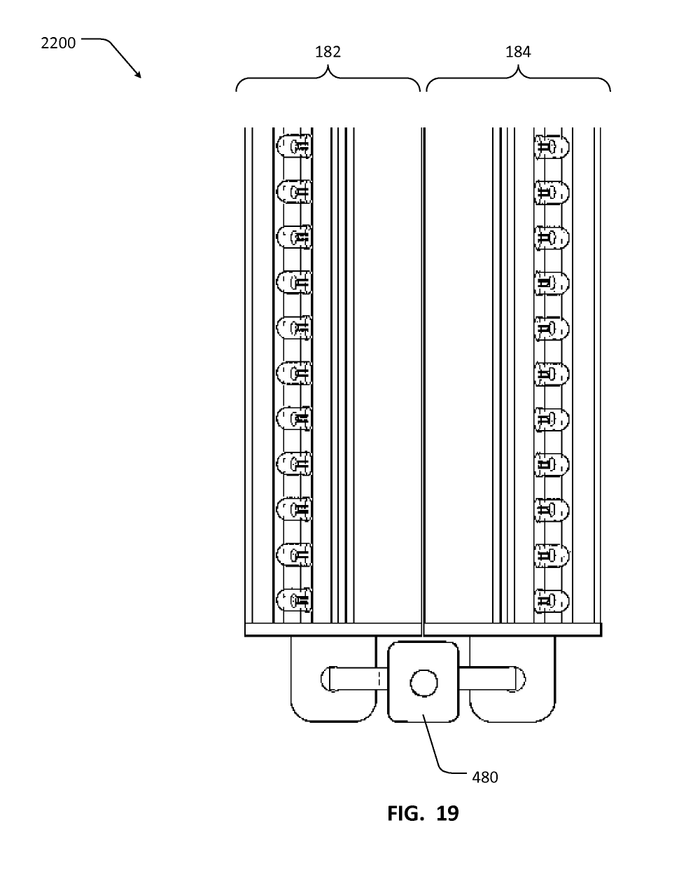

In another alternative embodiment of the central mullion lighting module 180 (of FIGS. 1 and 2), the central mullion lighting module 180 can be configured as two end jamb lighting modules 1100 (of FIGS. 4 through 10) mounted side-by-side on the center mullion 114. FIG. 19 illustrates an alternative embodiment 2200 of the central mullion lighting module 180 configured as two end jamb lighting modules 182 and 184.

Referring to FIGS. 1, 2, and 19, each of these end jamb lighting modules 182 and 184 has the same configuration as the end jamb lighting modules 1100 (of FIGS. 4 through 10). A clip 480 can be used to hold the lighting modules 182 and 183 side-by-side. In this configuration, the display case 1000 essentially has four end jamb lighting modules—the first end jamb lighting module 170, the second end jamb lighting module 190, the third end jamb lighting module 182, and the fourth end jamb lighting module 174. The third and the fourth end jamb lighting modules 182 and 184 are positioned to face different directions.

### Conclusion

From the foregoing, it will be appreciated that the present invention is novel and offers advantages over the current art. For example, with the advantages of simplicity of construction and extremely uniform lighting of the products to be illuminated, the end jamb and center mullion lighting fixtures described herein have several advantages over the prior art. Although a specific embodiment of the invention is described and illustrated above, the invention is not to be limited to the specific forms or arrangements of parts so described and illustrated. For example, differing configurations, sizes, or materials may be used to practice the present invention. The invention is limited by the claims that follow.

What is claimed is:

1. A display case comprising:
panels defining at least partially enclosed space, said display case having a first end jamb;
a first end jamb lighting module running along the first end jamb;
said first end jamb lighting module comprising:
a lighting module shell;
a first substrate affixed to said shell; and
lighting elements mounted on said first substrate.

2. The display case recited in claim 1 wherein said panels define a second end jamb and a center mullion, the display case further comprising:
a second end jamb lighting module running along the second end jamb;
a center mullion lighting module running along the center mullion;
wherein said second end jamb lighting module comprising:
a shell;
a first substrate affixed to said shell; and
lighting elements mounted on said first substrate.

3. The display case recited in claim 2 wherein said center mullion lighting module comprises:
a third end jamb lighting module oriented in a first direction; and
a fourth end jamb lighting module mounted proximal to said third end jamb lighting module, said fourth end jamb module oriented in a second direction.

4. The display case recited in claim 2 wherein said center mullion lighting module comprises:
a shell;
a first substrate affixed to said shell;
lighting elements mounted on said first substrate;
a second substrate affixed to said shell;
electrical components mounted on said second substrate, said electrical components connected to the lighting elements of said first substrate;
a third substrate affixed to said shell;
lighting elements mounted on said third substrate.

5. The display case recited in claim 1 wherein said shell defines a plurality of engagement slots such that said first substrate is affixed to said shell by placing portions of the said first substrate within the engagement slots.

6. The display case recited in claim 1 wherein said first end jamb lighting module further comprises:
a second substrate affixed to said shell; and
electrical components mounted on said second substrate, said electrical components connected to the lighting elements of said first substrate.

7. The display case recited in claim 1 wherein said shell defines an aperture through which light from the lighting elements is projected, and wherein said shell including a reflective surface proximal to the aperture.

8. The display case recited in claim 1 wherein said shell defines an aperture through which light from the lighting elements is projected, and said first end jamb lighting module further comprising a reflector positioned proximal to the aperture, the reflector adapted to reflect light from the lighting elements in a desired direction.

9. The display case recited in claim 1 wherein said shell defines an aperture through which light from the lighting elements is projected and said first end jamb lighting module further comprising an optical cover covering at least a portion of the aperture.

10. The display case recited in claim 9 wherein said shell defines a cover tuck insert to which a portion of the cover engages.

11. The display case recited in claim 1 wherein said lighting elements are light emitting diodes.

12. The display case recited in claim 1 wherein said shell defines at least one engagement slot and said first substrate is affixed to said shell at the engagement slot.

13. The display case recited in claim 1 further comprising an engagement device adapted to engage said first substrate to said shell, said engagement device selected from the group consisting of attachment screw, adhesive, and clip.

14. The display case recited in claim 1 wherein said first lighting module further comprises a quick-disconnect connector adapted to engage with a mated connector through which external electrical power is supplied to said first lighting module.

15. The display case recited in claim 1 wherein said first end jamb lighting module further comprises:
a second substrate affixed to said shell; and
electrical components mounted on said second substrate, said electrical components connected to the lighting elements.

16. The display case recited in claim 15 wherein said shell defines a plurality of engagement slots such that said first substrate is affixed to said shell by placement of portions of said first substrate within a first set of engagement slots.

17. A display case comprising:
panels defining at least partially enclosed space, said panels also defining a first end jamb, a second end jamb, and a center mullion;
a first end jamb lighting module running along the first end jamb;
a second end jamb lighting module running along the second end jamb;
a center mullion lighting module running along center mullion;
wherein each lighting module comprising:
a lighting module shell;
a first substrate affixed to said shell; and
lighting elements mounted on said shell.

18. The display case recited in claim 17 wherein each lighting module further comprising:
a second substrate affixed to said shell;
electrical components mounted on said second substrate, said electrical components connected to the lighting elements.

19. The display case recited in claim 17 wherein each shell defines at least one aperture, and each lighting module further comprising a reflective surface proximal to the aperture.

20. A lighting module comprising
a lighting module shell, said shell defining at least one engagement slot;
a first a substrate affixed to said shell at the engagement slot; and
lighting elements mounted on said substrate.

21. The lighting module recited in claim 20 where said shell comprises a reflector flange portion for supporting a reflector adapted to reflect light from said lighting elements toward a desired direction.

22. The lighting module recited in claim 20 where said shell comprises a reflector flange portion for adapted to reconfigure the spatial distribution of light from said lighting elements.

23. The lighting module recited in claim 20 where
said shell defines a cover flange;
said shell defines a tuck insert; and
an optical cover partially wraps around said cover flange and edge of said optical cover is inserted into the tuck insert.

24. The lighting module recited in claim 20 further comprising:
a first end plate fastened to a first end of said shell; and
a second end plate fastened to a second end of said shell.
